(19) United States
(12) Patent Application Publication
(10) Pub. No.: US 2020/0015075 A1
(43) Pub. Date: Jan. 9, 2020

(54) VEHICLE COMMUNICATION MONITORING APPARATUS, VEHICLE COMMUNICATION MONITORING METHOD, AND COMPUTER READABLE MEDIUM

(71) Applicant: Mitsubishi Electric Corporation, Tokyo (JP)

(72) Inventor: Yuya TAKATSUKA, Tokyo (JP)

(73) Assignee: Mitsubishi Electric Corporation, Tokyo (JP)

(21) Appl. No.: 16/475,296

(22) PCT Filed: Feb. 28, 2017
(86) PCT No.: PCT/JP2017/007946

§ 371 Date: Jul. 1, 2019

(51) Int. Cl. H04W 12/00; H04L 29/06

(52) U.S. Cl. CPC H04W 12/005; H04W 4/40; H04L 63/1441; H04L 63/101

(57) ABSTRACT

A storage unit stores message information in which a vehicle state, a message attribute that specifies a message to be communicated, and permission information on communication of the message specified by the message attribute are associated with one another. A protocol conversion unit acquires, as a communication message, a message to be communicated between an in-vehicle system and an external system. Based on a message attribute that specifies the communication message, a current state which is a current state of a vehicle, and the message information, a determination unit determines whether communication of the communication message is permitted when the vehicle is in the current state.

### TECHNICAL FIELD

The present invention relates to a vehicle communication monitoring apparatus, a vehicle communication monitoring method, and a vehicle communication monitoring program that have an attack detection method for vehicles.

### BACKGROUND ART

In recent years, an in-vehicle apparatus such as a car navigation system or a head unit has a communication function with a network external to a vehicle and provides connection to the Internet or a remote service function. The in-vehicle apparatus is connected with a carry-in device such as a mobile phone, a smartphone, or a personal computer (PC) by a communication method such as a wireless local area network (LAN) or Bluetooth (registered trademark). Equipping the in-vehicle apparatus with the communication function like this has increased the risk of hacking of automobiles via the Internet, by misuse of the carry-in device, or the like. As countermeasures against hacking, various techniques such as packet filtering by a firewall and an attack detection method have been considered.

Patent Literature 1 discloses an attack detection technique of monitoring a communication message flowing in a vehicle network, and determining that an anomaly has occurred in the communication state of the communication message if a reception interval is shorter than a prescribed appropriate reception interval. Patent Literature 1 also discloses a method of determining that an anomaly has occurred in the communication state of another communication message if the reception interval is longer than the prescribed reception interval.

Patent Literature 2 discloses a vehicle network monitoring apparatus that monitors communication data in a vehicle network, and determines the communication data to be unauthorized data if the communication format of the communication data is different from a prescribed format, thereby maintaining high security for the vehicle network.

### CITATION LIST

### Patent Literature

Patent Literature 1: JP 2014-187445 A

Patent Literature 2: JP 5522160 B

### SUMMARY OF INVENTION

### Technical Problem

The conventional attack detection technique detects an attack on the basis of the communication cycle, and therefore a problem is that it cannot cope with communication in which the communication cycle or the communication volume changes depending on the state of a vehicle. Note that the communication volume includes permission or prohibition of communication. Another problem is that the conventional attack detection technique is not suitable for communication in which reception timing changes due to an external factor such as the Internet.

Also in the case where communication data is determined to be unauthorized data if the communication format of the communication data is different from the prescribed format, a problem is that consideration is not given to communication in which the communication cycle or the communication volume changes depending on the state of a vehicle.

It is an object of the present invention to protect an in-vehicle system by blocking an unauthorized message in accordance with the state of a vehicle, such as traveling or stationary and doors open or closed.

### Solution to Problem

A vehicle communication monitoring apparatus according to the present invention includes:

a storage unit to store message information in which a vehicle state that indicates a state of a vehicle, a message attribute that specifies a message to be communicated, and permission information that indicates whether communication of the message specified by the message attribute is permitted are associated with one another;

a state acquisition unit to acquire a current state of the vehicle as a current state;

a message acquisition unit to acquire, as a communication message, a message to be communicated between an in-vehicle system installed in the vehicle and an external system not installed in the vehicle; and

a determination unit to acquire, as a communication message attribute, a message attribute that specifies the communication message, and based on the current state, the communication message attribute, and the message information, determine whether communication of the communication message is permitted when the vehicle is in the current state.

### Advantageous Effects of Invention

In a vehicle communication monitoring apparatus according to the present invention, a storage unit stores message information in which a vehicle state that indicates a state of a vehicle, a message attribute that specifies a message to be communicated, and permission information that indicates whether communication of the message specified by the message attribute is permitted are associated with one another. A state acquisition unit acquires a current state of the vehicle as a current state. A message acquisition unit acquires, as a communication message, a message to be communicated between an in-vehicle system installed in the vehicle and an external system not installed in the vehicle. A determination unit acquires, as a communication message attribute, a message attribute that specifies the communication message, and based on the current state, the communication message attribute, and the message information, determines whether communication of the communication message is permitted when the vehicle is in the current state. Therefore, according to the vehicle communication monitoring apparatus of the present invention, whether the communication of the message is permitted can be determined in accordance with the state of the vehicle, so that vehicle communication can be monitored more appropriately.

### BRIEF DESCRIPTION OF DRAWINGS

FIG. 1 is a configuration diagram of a vehicle communication monitoring apparatus 100 according to a first embodiment;

FIG. 2 is an example of message information 181 according to the first embodiment;

FIG. 3 is an example of message information 181x according to the first embodiment;

FIG. 4 is an example of message information 181y according to the first embodiment;

FIG. 5 is a flowchart illustrating a message information acquisition process S10 according to the first embodiment;

FIG. 6 is a flowchart illustrating a state acquisition process S20 according to the first embodiment;

FIG. 7 is a flowchart illustrating a determination process S30 according to the first embodiment;

FIG. 8 is a flowchart illustrating a message acquisition process S40 according to the first embodiment;

FIG. 9 is a configuration diagram of a vehicle communication monitoring apparatus 100 according to a variation of the first embodiment;

FIG. 10 is a configuration diagram of a vehicle communication monitoring apparatus 100a according to a second embodiment;

FIG. 11 is an example of message information 181a according to the second embodiment;

FIG. 12 is a flowchart illustrating a communication volume acquisition process S50 according to the second embodiment;

FIG. 13 is a flowchart illustrating a determination process S30a according to the second embodiment; and

FIG. 14 is a flowchart illustrating a message acquisition process S40a according to the second embodiment.

### DESCRIPTION OF EMBODIMENTS

Embodiments of the present invention will be described hereinafter with reference to the drawings. In the drawings, the same or corresponding parts are denoted by the same or corresponding reference signs. In the description of the embodiments, description of the same or corresponding parts will be omitted or simplified as appropriate.

### First Embodiment

***Description of Configuration***

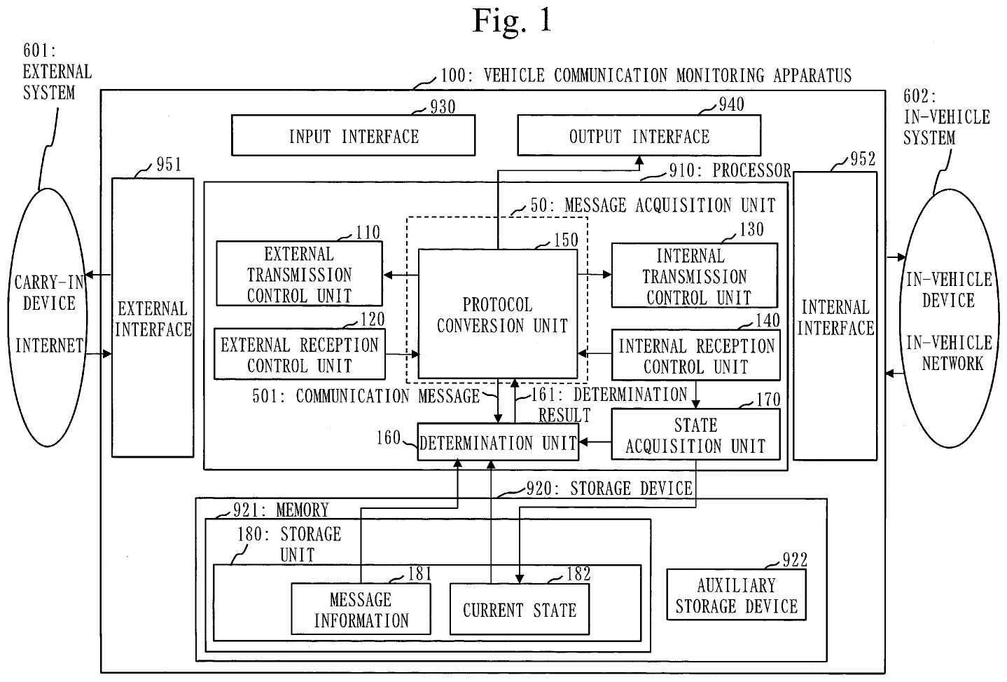

A configuration of a vehicle communication monitoring apparatus 100 according to this embodiment will be described with reference to FIG. 1.

The vehicle communication monitoring apparatus 100 is an in-vehicle gateway installed in a vehicle. The vehicle communication monitoring apparatus 100 controls communication between an in-vehicle system 602 installed in the vehicle and an external system 601 not installed in the vehicle, and also monitors communication between the in-vehicle system 602 and the external system 601.

The in-vehicle system 602 installed in the vehicle includes devices, such as a head unit, an electronic control unit (ECU), and a car navigation system, and a vehicle internal network connecting these devices.

The external system 601 not installed in the vehicle includes a vehicle external network and devices such as a carry-in device. Specifically, the carry-in device is a device such as a mobile phone, a smartphone, a PC, or an on-board diagnostics (OBD) tool.

As illustrated in FIG. 1, the vehicle communication monitoring apparatus 100 is a computer.

The vehicle communication monitoring apparatus 100 has hardware, such as a processor 910, a storage device 920, an input interface 930, an output interface 940, an external interface 951, and an internal communication interface 952. The storage device 920 includes a memory 921 and an auxiliary storage device 922.

The vehicle communication monitoring apparatus 100 has, as functional components, an external transmission control unit 110, an external reception control unit 120, an internal transmission control unit 130, an internal reception control unit 140, a protocol conversion unit 150, a determination unit 160, a state acquisition unit 170, and a storage unit 180.

The function of each of the external transmission control unit 110, the external reception control unit 120, the internal transmission control unit 130, the internal reception control unit 140, the protocol conversion unit 150, the determination unit 160, and the state acquisition unit 170 is realized by software. In the following description, the external transmission control unit 110, the external reception control unit 120, the internal transmission control unit 130, the internal reception control unit 140, the protocol conversion unit 150, the determination unit 160, and the state acquisition unit 170 are referred to as the units of the vehicle communication monitoring apparatus 100. Note that the storage unit 180 is not included in the units of the vehicle communication monitoring apparatus 100.

The storage unit 180 stores message information 181 and a current state 182.

The storage unit 180 is realized by the memory 921. Alternatively, the storage unit 180 may be realized solely by the auxiliary storage device 922, or by the memory 921 and the auxiliary storage device 922. The storage unit 180 may be realized by any method.

The processor 910 is connected to other hardware components via signal lines and controls these other hardware components. The processor 910 is an integrated circuit (IC) that performs arithmetic processing. Specific examples of the processor 910 are a central processing unit (CPU), a digital signal processor (DSP), and a graphics processing unit (GPU).

The memory 921 is a storage device to temporarily store data. Specific examples of the memory 921 are a static random access memory (SRAM) and a dynamic random access memory (DRAM).

The auxiliary storage device 922 is a storage device to store data. A specific example of the auxiliary storage device 922 is a hard disk drive (HDD). Alternatively, the auxiliary storage device 922 may be a portable storage medium, such as a Secure Digital (SD) (registered trademark) memory card, CompactFlash (CF), NAND flash, a flexible disk, an optical disc, a compact disc, a Blu-ray (registered trademark) disc, or a digital versatile disc (DVD).

The input interface 930 is a port which is connected with an input device such as a keyboard or a touch panel. Specifically, the input interface 930 is a Universal Serial Bus (USB) terminal. The input interface 930 may be a port which is connected with a LAN.

The output interface 940 is a port to which a cable of a display device, such as a display, is connected. Specifically, the output interface 940 is a USB terminal or a High Definition Multimedia Interface (HDMI) (registered trademark) terminal. Specifically, the display is a liquid crystal display (LCD).

The external interface 951 has a communication function between the vehicle communication monitoring apparatus 100 which is the in-vehicle gateway and the external system 601 not installed in the vehicle. Specifically, the external interface 951 has the communication function between the vehicle communication monitoring apparatus 100 and a carry-in device or a network external to the vehicle such as the Internet.

The internal interface 952 has a communication function between the vehicle communication monitoring apparatus 100 which is the in-vehicle gateway and the in-vehicle system 602 installed in the vehicle. Specifically, the internal interface 952 has the communication function between the vehicle communication monitoring apparatus 100 and a device, such as the head unit or the ECU, on the vehicle internal network.

The auxiliary storage device 922 stores a program for realizing the functions of the units of the vehicle communication monitoring apparatus 100. The program for realizing the functions of the units of the vehicle communication monitoring apparatus 100 is also referred to as a vehicle communication monitoring program 620. This program is loaded into the memory 921, read by the processor 910, and executed by the processor 910. The auxiliary storage device 922 also stores an OS. At least part of the OS in the auxiliary storage device 922 is loaded into the memory 921. The processor 910 executes the vehicle communication monitoring program 620 while executing the OS.

The vehicle communication monitoring apparatus 100 may include only one processor 910, or may include a plurality of processors 910. The plurality of processors 910 may cooperate to execute the program for realizing the functions of the units of the vehicle communication monitoring apparatus 100.

Information, data, signal values, and variable values that indicate results of processing by the units of the vehicle communication monitoring apparatus 100 are stored in the auxiliary storage device 922 or the memory 921 of the vehicle communication monitoring apparatus 100, or a register or a cache memory in the processor 910.

The program for realizing the functions of the units of the vehicle communication monitoring apparatus 100 may be stored in a portable recording medium. Specifically, the portable recording medium is a magnetic disk, a flexible disk, an optical disc, a compact disc, a Blu-ray (registered trademark) disc, a digital versatile disc (DVD), or a memory card such as an SD (registered trademark) card.

Note that a vehicle communication monitoring program product is a storage medium or a storage device in which the vehicle communication monitoring program 620 is recorded. The vehicle communication monitoring program product refers to a product of any appearance on which a computer readable program is loaded.

***Description of Functions***

The functions of the units and the storage unit 180 of the vehicle communication monitoring apparatus 100 according to this embodiment will be described with reference to FIG. 1.

The external transmission control unit 110 receives a message from the protocol conversion unit 150, and transmits the message to the vehicle external network such as the carry-in device or the Internet. The external reception control unit 120 receives a message from the vehicle external network such as the carry-in device or the Internet, and outputs the message to the protocol conversion unit 150.

Each of the external transmission control unit 110 and the external reception control unit 120 employs a connection method such as a wireless LAN, Bluetooth (registered trademark), USB, OBD, 3G, or LTE (registered trademark) for communication with the carry-in device or the vehicle external network such as the Internet. Note that the connection method is not limited.

On the other hand, the internal transmission control unit 130 receives a message from the protocol conversion unit 150, and transmits the message to the vehicle internal network. The internal reception control unit 140 receives a message from the vehicle internal network, and outputs the message to the protocol conversion unit 150. Each of the internal transmission control unit 130 and the internal reception control unit 140 employs a connection method such as CAN, FlexRay, MOST, LIN, or Ethernet (registered trademark) for communication with the vehicle internal network. Note that the communication method is not limited.

The protocol conversion unit 150 receives a message received through the external interface 951 from the external reception control unit 120. Then, the protocol conversion unit 150 executes the program stored in the memory 921 with the processor 910 to convert the message in accordance with a protocol for communication with a device on the vehicle internal network. Then, the protocol conversion unit 150 outputs the converted message as a communication message 501 to the determination unit 160, and outputs the converted message to the internal transmission control unit 130 if it is not determined to be an attack. On the other hand, the protocol conversion unit 150 receives a message received through the internal interface 952 from the internal reception control unit 140. Then, the protocol conversion unit 150 executes the program stored in the memory 921 with the processor 910 to convert the message in accordance with a protocol for communication with an external device such as the carry-in device or the Internet. Then, the protocol conversion unit 150 outputs the converted message as a communication message 501 to the determination unit 160, and outputs the converted message to the external transmission control unit 110 if it is not determined to be an attack.

The protocol conversion unit 150 is an example of a message acquisition unit 50 that acquires, as a communication message 501, a message to be communicated between the in-vehicle system 602 installed in the vehicle and the external system 601 not installed in the vehicle.

The determination unit 160 executes the program stored in the memory 921 with the processor 910 to perform the following operation. The determination unit 160 acquires the message information 181 from the storage unit 180 when the vehicle communication monitoring apparatus 100 which is the in-vehicle gateway starts up. The determination unit 160 receives a notification regarding the current state of the vehicle from the state acquisition unit 170. Upon receiving a message from the protocol conversion unit 150, the determination unit 160 determines whether the transfer of the message is permitted based on the message information 181 and the current state of the vehicle, and notifies the protocol conversion unit 150 of the result.

The determination unit 160 is also referred to as an attack detection unit that detects an attack on vehicle communication.

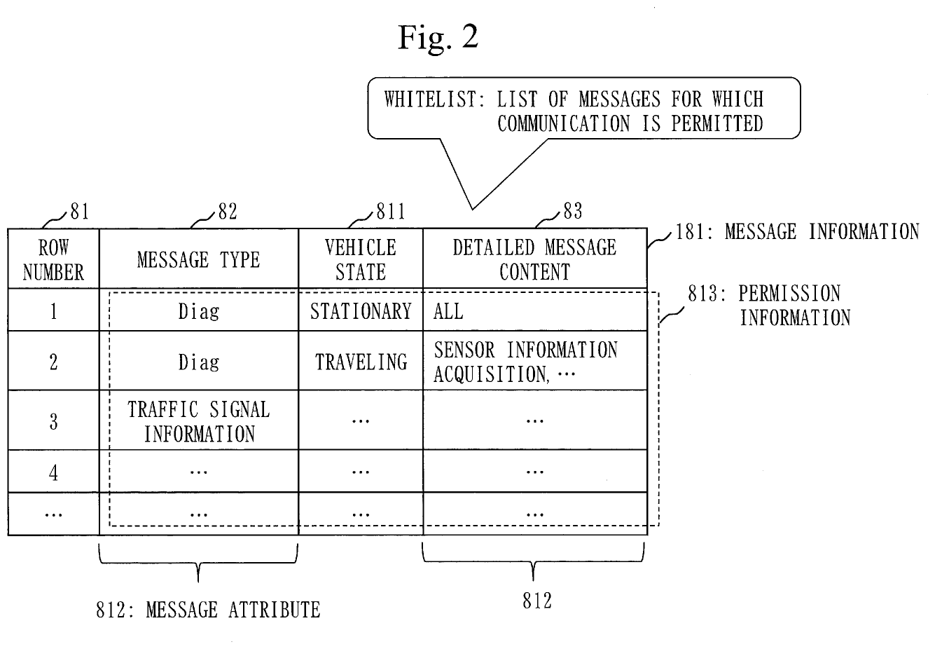

An example of the message information 181 according to this embodiment will be described with reference to FIG. 2.

The storage unit 180 stores the message information 181 in which a vehicle state 811 that indicates the state of the vehicle, a message attribute 812 that specifies a message to be communicated, and permission information 813 that indicates whether the communication of the message specified by the message attribute is permitted are associated with one another. The message information 181 is also referred to as an attack detection list table.

Specifically, information such as a row number 81, a message type 82, the vehicle state 811, and detailed message content 83 is registered in the message information 181.

A specific example of the message type 82 is a type such as Diag or traffic signal information.

The detailed message content 83 indicates the content of the message. The detailed message content 83 is a further detailed classification of the message type. As a specific example, “sensor information acquisition command” or “all” may be specified.

The message information 181 includes the message type 82 and the detailed message content 83 which is the content of the message, as the message attribute 812 that specifies the message to be communicated.

The vehicle state 811 indicates the state of the vehicle. A specific example of the vehicle state 811 is the state of the vehicle, such as “stationary”, “traveling”, “doors open”, or “doors closed”. The message information 181 includes, as the vehicle state 811, at least one of the traveling state of the vehicle such as “stationary” or “traveling” and the open or closed state of doors of the vehicle such as “doors open” or “doors closed”.

Note that the items and contents of the message information 181 indicated here are an example, and the items and contents of the message information 181 are not limited to this example.

The message information 181 illustrated in FIG. 2 is a whitelist such that the fact that the message attribute 812 is set therein is the permission information 813 indicating that the communication of the message specified by the message attribute 812 is permitted. That is, a messages for which communication and transfer are permitted is set in the message information 181. In this case, the message attribute 812 set in the message information 181 is the permission information 813 indicating that the communication of the message is permitted.

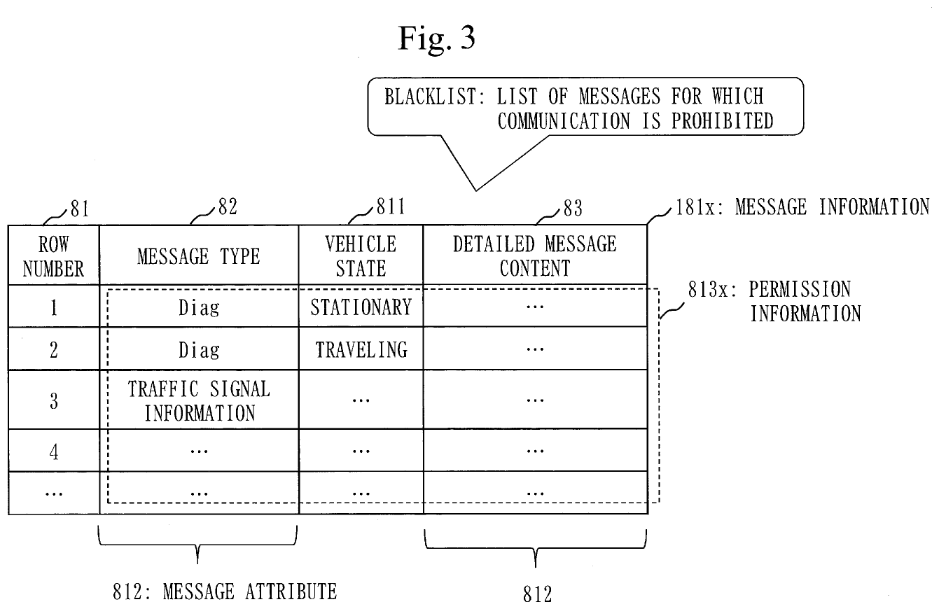

An example of message information 181x according to this embodiment will be described with reference to FIG. 3.

As illustrated in the message information 181x of FIG. 3, the message information 181x may be a blacklist such that the fact that a message attribute is set therein is the permission information 813x indicating that the communication of a message specified by the message attribute is not permitted. That is, a message for which communication and transfer are prohibited may be set in the message information 181x. In this case, the message attribute set in the message information 181x is the permission information 813x indicating that the communication of the message is prohibited.

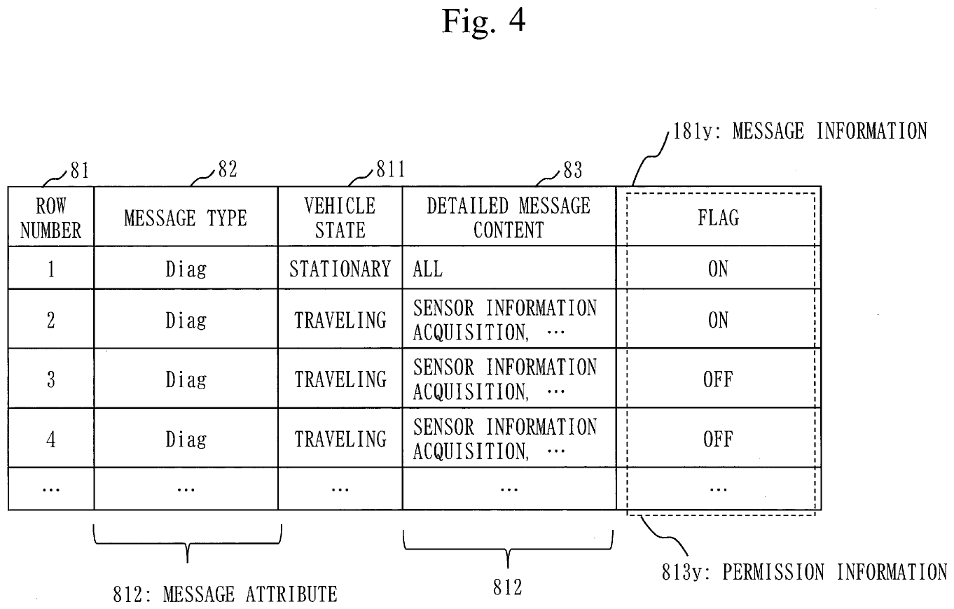

Message information 181y which is another example of the message information 181 according to this embodiment will be described with reference to FIG. 4.

As illustrated in the message information 181y of FIG. 4, the message information 181y may include, as the permission information 813y, a flag which indicates whether or not the communication of the message is permitted based on whether the flag is on or off.

***Description of Operation***

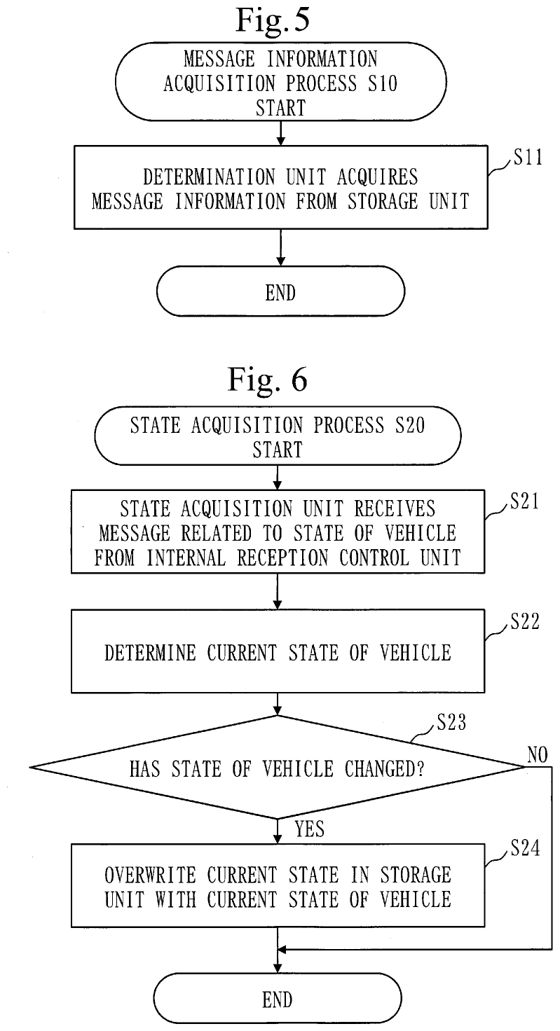

A vehicle communication monitoring process S100 of a vehicle communication monitoring method 610 and the vehicle communication monitoring program 620 according to this embodiment will be described with reference to FIGS. 5 to 8. FIGS. 5 to 8 are diagrams illustrating an example of flowcharts when the vehicle communication monitoring apparatus 100 which is the in-vehicle gateway installed in the vehicle receives a message from the external system 601 such as the carry-in device or the Internet. Note that the flowcharts of FIGS. 5 to 8 describe a case where the message information 181 of the whitelist type illustrated in FIG. 2 is used. The vehicle communication monitoring process S100 has a message information acquisition process S10, a state acquisition process S20, a determination process S30, and a message acquisition process S40.

<Message Information Acquisition Process S10>

The message information acquisition process S10 according to this embodiment will be described with reference to FIG. 5.

In step S11, the determination unit 160 acquires the message information 181 from the storage unit 180.

<State Acquisition Process S20>

The state acquisition process S20 according to this embodiment will be described with reference to FIG. 6.

In the state acquisition process S20, the state acquisition unit 170 acquires the current state of the vehicle as the current state 182. A specific process of the state acquisition process S20 is as described below.

In step S21, the state acquisition unit 170 receives a message related to the state of the vehicle from the internal reception control unit 140.

In step S22, the state acquisition unit 170 determines the current state of the vehicle based on the message received from the internal reception control unit 140. Specifically, the state acquisition unit 170 determines whether the vehicle is traveling or stationary based on vehicle speed information.

In step S23, the state acquisition unit 170 compares the current state 182 stored in the storage unit 180 with the current state of the vehicle determined in step S22. If the current state of the vehicle is different from the current state 182, that is, if the current state of the vehicle has changed from the current state 182, the state acquisition unit 170 proceeds to step S24. If the current state of the vehicle is identical with the current state 182, that is, if the current state of the vehicle has not changed from the current state 182, the state acquisition unit 170 terminates the process.

In step S24, the state acquisition unit 170 overwrites the current state 182 in the storage unit 180 with the current state of the vehicle.

<Determination Process S30>

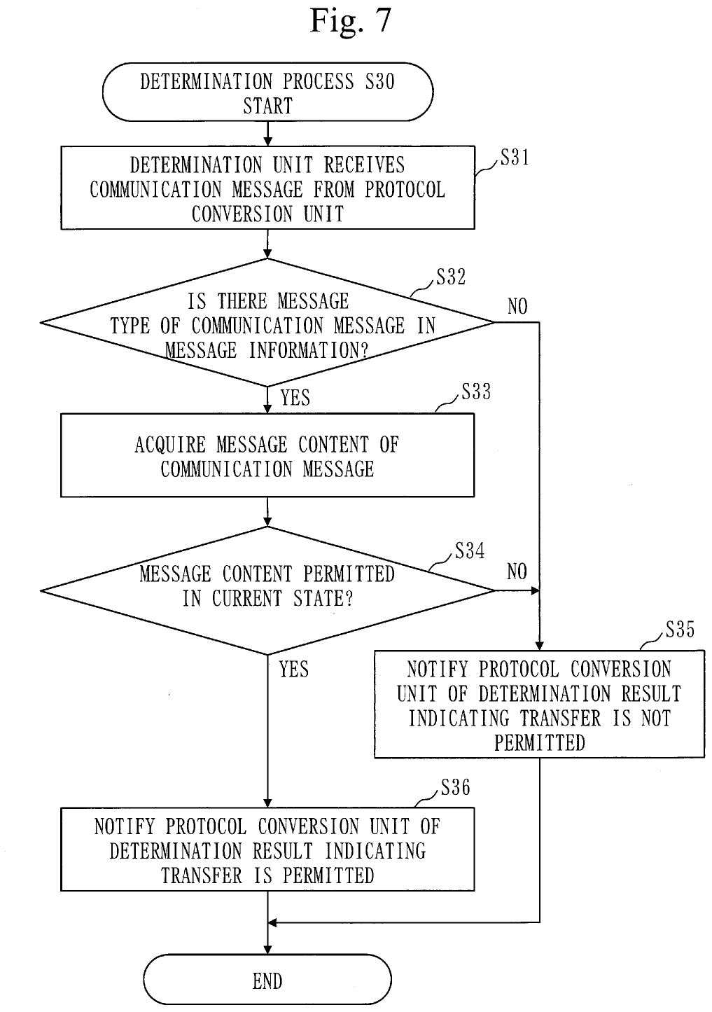

The determination process S30 according to this embodiment will be described with reference to FIG. 7.

In the determination process S30, the determination unit 160 acquires, as a communication message attribute 502, a message attribute that specifies the communication message 501 to be communicated between the in-vehicle system 602 and the external system 601. Based on the current state 182, the communication message attribute 502, and the message information 181, the determination unit 160 determines whether the communication of the communication message 501 is permitted when the vehicle is in the current state 182. Then, the determination unit 160 outputs to the message acquisition unit 50 a determination result 161 indicating whether the communication of the communication message 501 is permitted. A specific process of the determination process S30 is as described below.

In step S31, the determination unit 160 receives the communication message 501 from the protocol conversion unit 150. The determination unit 160 acquires the communication message attribute 502 that specifies the communication message 501. The communication message attribute 502 includes a message type of the communication message 501 and message content of the communication message 501.

In step S32, the determination unit 160 checks whether the message type 82 of the message information 181 acquired in the message information acquisition process S10 includes one corresponding with the message type included in the communication message attribute 502. If there is one, the process proceeds to step S33. If there is none, the process proceeds to step S35.

In step S33, the determination unit 160 analyzes the communication message 501 and acquires the message content of the communication message 501.

In step S34, based on the message information 181, the current state 182 of the vehicle, and the message content of the communication message 501, the determination unit 160 determines whether transfer is permitted for the communication message 501 when the vehicle is in the current state 182. If permitted, the process proceeds to step S36. If not permitted, the process proceeds to step S35.

In step S35, the determination unit 160 outputs to the protocol conversion unit 150 the determination result 161 indicating that the transfer is not permitted.

In step S36, the determination unit 160 outputs to the protocol conversion unit 150 the determination result 161 indicating that the transfer is permitted.

<Message Acquisition Process S40>

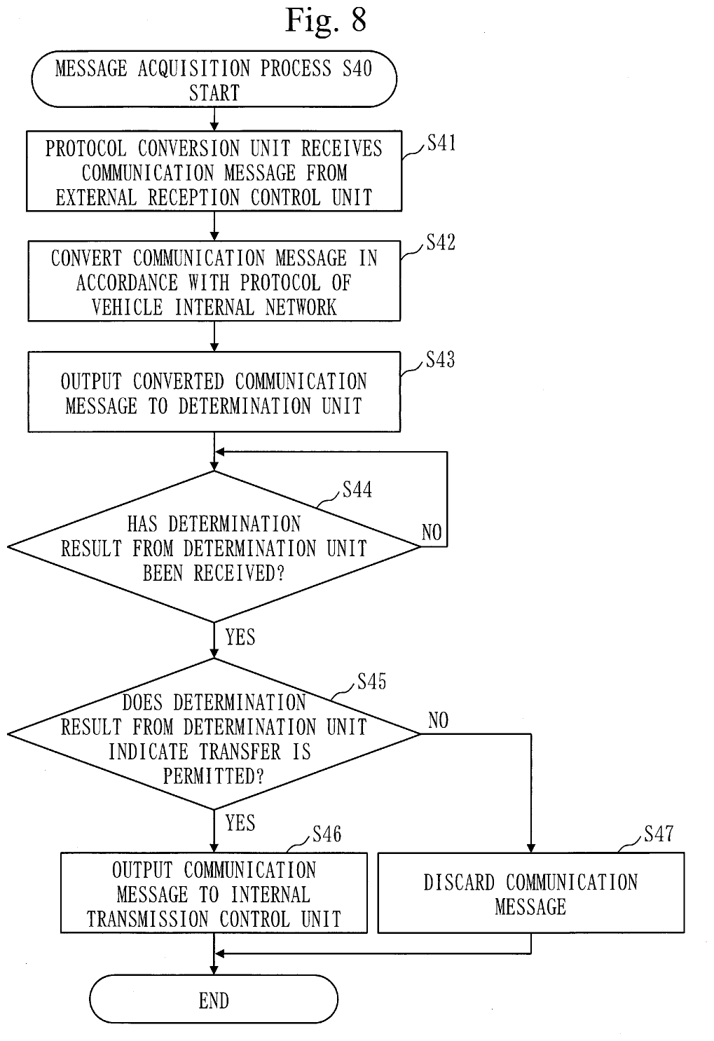

The message acquisition process S40 according to this embodiment will be described with reference to FIG. 8.

In the message acquisition process S40, the protocol conversion unit 150 acquires, as the communication message 501, the message to be communicated between the in-vehicle system 602 installed in the vehicle and the external system 601 not installed in the vehicle. The protocol conversion unit 150 performs protocol conversion on the communication message 501 and outputs the converted communication message 501 to the determination unit 160. Then, the determination result 161 from the determination unit 160 is received, and the communication of the communication message 501 is controlled based on the determination result 161. If the determination result 161 indicates that the communication is not permitted, the message acquisition unit 50 discards the communication message 501. Alternatively, if the determination result 161 indicates that the communication is not permitted, the message acquisition unit 50 may discard the communication message 501 and also output to an output device an indication that the communication is not permitted for the communication message 501. The message acquisition process S40 is also referred to as a protocol conversion process. A specific process of the message acquisition process S40 is as described below.

In step S41, the protocol conversion unit 150 receives the communication message 501 from the external reception control unit 120.

In step S42, the protocol conversion unit 150 converts the communication message 501 received from the external reception control unit 120 in accordance with the protocol of the vehicle internal network which is the in-vehicle system 602 to be the destination.

In step S43, the protocol conversion unit 150 outputs the converted communication message 501 to the determination unit 160.

In step S44, the protocol conversion unit 150 waits for a response from the determination unit 160. Upon receiving the determination result 161 as the response, the protocol conversion unit 150 proceeds to step S45.

In step S45, if the determination result 161 from the determination unit 160 indicates that the transfer is permitted, the protocol conversion unit 150 proceeds to step S46. If the determination result 161 from the determination unit 160 indicates that the transfer is not permitted, the protocol conversion unit 150 proceeds to step S47.

In step S46, the protocol conversion unit 150 outputs the communication message 501 to the internal transmission control unit 130. That is, since the communication message 501 is determined not to be an unauthorized message, the protocol conversion unit 150 performs a normal process on the communication message 501.

In step S47, the protocol conversion unit 150 discards the communication message 501. That is, since the communication message 501 is determined to be an unauthorized message, the protocol conversion unit 150 blocks the communication message 501 by discarding it.

***Other Configurations***

The vehicle communication monitoring apparatus 100 according to this embodiment may include a function of, upon blocking an unauthorized message, notifying a driver of the vehicle that the unauthorized message has been blocked, via an output device such as a display or a speaker. Such a function allows the driver to recognize that the in-vehicle system 602 is under attack and take countermeasures such as stopping the vehicle.

In this embodiment, an attack detection method for 2a message from the outside of the vehicle to the inside of the vehicle has been described in detail. However, a message from the inside of the vehicle to the outside of the vehicle may also be processed similarly. This can prevent leakage of confidential information or private information by an unauthorized operation of the in-vehicle system 602. Note that when a message from the inside of the vehicle to the outside of the vehicle is processed, the protocol conversion unit transmits the message before protocol conversion received from the internal reception control unit to the determination unit as a communication message. Then, if the determination result from the determination unit indicates that the transfer is permitted, the protocol conversion unit converts the protocol of the communication message and outputs the converted communication message to the external transmission control unit.

In this embodiment, the functions of the units of the vehicle communication monitoring apparatus 100 are realized by software. As a variation, however, the functions of the units of the vehicle communication monitoring apparatus 100 may be realized by hardware.

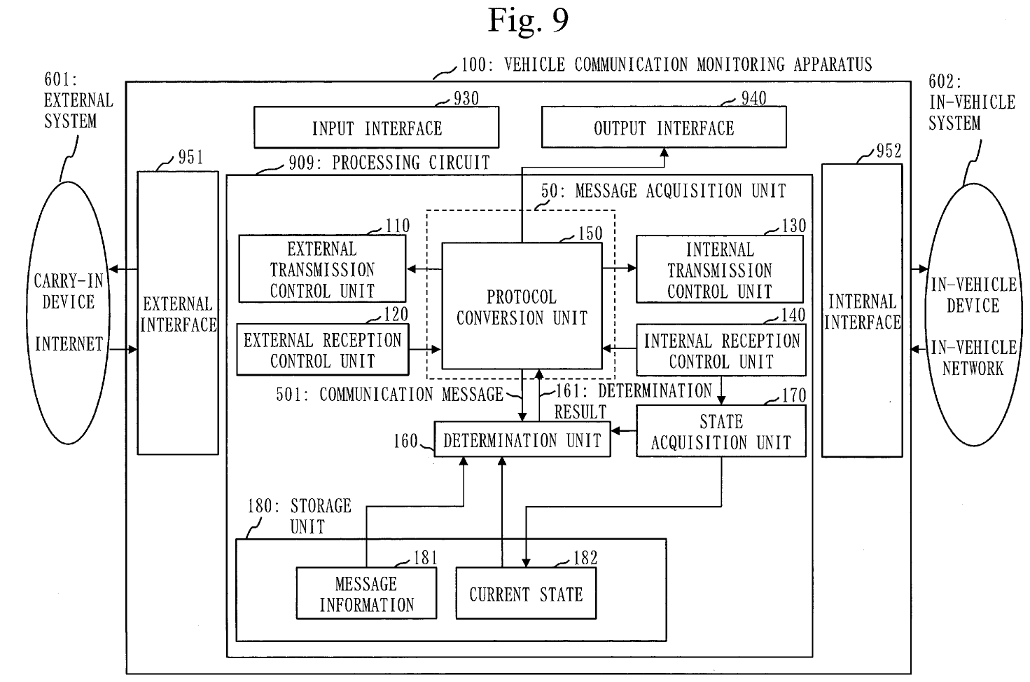

A configuration of a vehicle communication monitoring apparatus 100 according to a variation of this embodiment will be described with reference to FIG. 9. As illustrated in FIG. 9, the vehicle communication monitoring apparatus 100 includes hardware, such as a processing circuit 909, an input interface 930, an output interface 940, an external interface 951, and an internal communication interface.

The processing circuit 909 is a dedicated electronic circuit that realizes the functions of the units and the storage device 180 of the vehicle communication monitoring apparatus 100 described above. Specifically, the processing circuit 909 is a single circuit, a composite circuit, a programmed processor, a parallel programmed processor, a logic IC, a GA, an ASIC, or an FPGA. GA is an abbreviation for Gate Array. ASIC is an abbreviation for Application Specific Integrated Circuit. FPGA is an abbreviation for Field-Programmable Gate Array.

The functions of the units of the vehicle communication monitoring apparatus 100 may be realized by one processing circuit 909, or may be realized by being distributed among a plurality of processing circuits 909.

As another variation, the functions of the units of the vehicle communication monitoring apparatus 100 may be realized by a combination of software and hardware. That is, some of the functions of the vehicle communication monitoring apparatus 100 may be realized by dedicated hardware, and the rest of the functions may be realized by software.

The processor 910, the storage device 920, and the processing circuit 909 of the vehicle communication monitoring apparatus 100 are referred to collectively as “processing circuitry”. That is, the functions of the units and the storage unit 180 of the vehicle communication monitoring apparatus 100 are realized by the processing circuitry, regardless of whether the configuration of the vehicle communication monitoring apparatus 100 is the configuration illustrated in FIG. 1 or the configuration illustrated in FIG. 9.

The “unit” may be interpreted as a “step”, “procedure”, or “process”. The function of the “unit” may be realized by firmware.

***Description of Effects of This Embodiment***

As described above, the vehicle communication monitoring apparatus 100 according to this embodiment recognizes the state of the vehicle and prohibits the transmission of a message that is not permitted in the current state of the vehicle. Therefore, the vehicle communication monitoring apparatus 100 according to this embodiment prevents hacking of the in-vehicle system 602 by intrusion of an unauthorized message into the vehicle internal network.

### Second Embodiment

In this embodiment, differences from the first embodiment will be mainly described.

***Description of Configuration***

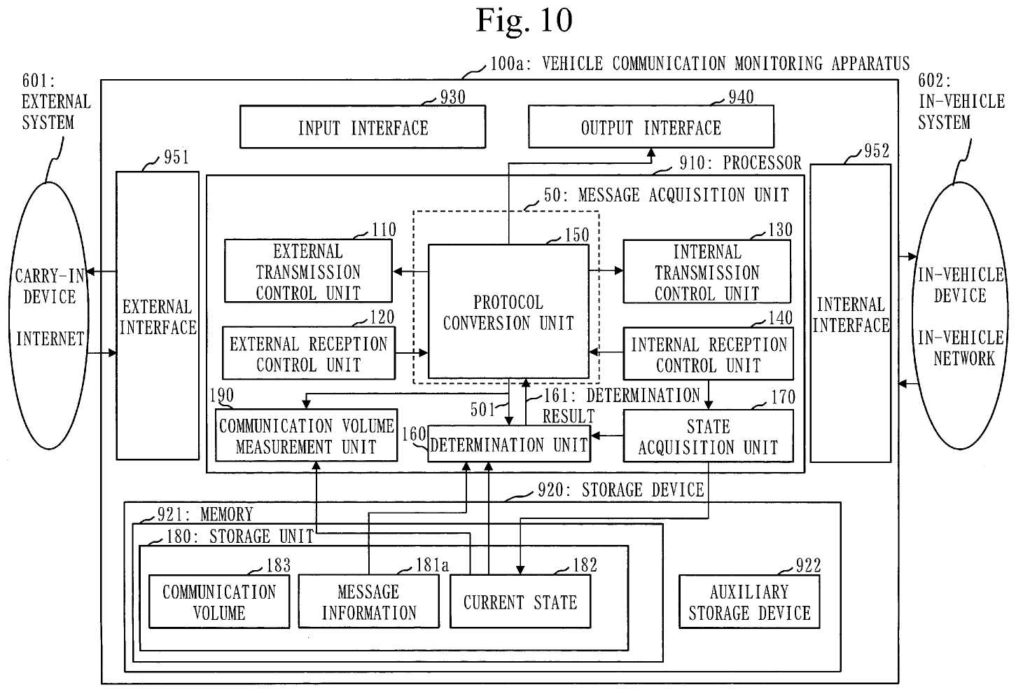

A configuration of a vehicle communication monitoring apparatus 100a according to this embodiment will be described with reference to FIG. 10. In FIG. 10, components substantially the same as the components described in the first embodiment are denoted by the same reference signs, and description thereof will be omitted.

The vehicle communication monitoring apparatus 100a according to this embodiment includes a communication volume measurement unit 190 in addition to the functional components of the vehicle communication monitoring apparatus 100a described in the first embodiment. The storage unit 180 stores message information 181a and a communication volume 183 in addition to the current state 182 described in the first embodiment. Other functional components and hardware are substantially the same as those of the first embodiment.

The communication volume measurement unit 190 receives a communication message 501 from the protocol conversion unit 150, and measures the communication volume of the communication message received in a fixed period of time. The communication volume measurement unit 190 updates the communication volume 183 in the storage device 180, using the measured communication volume as the communication volume received in the current state 182 for the message type of the communication message 501.

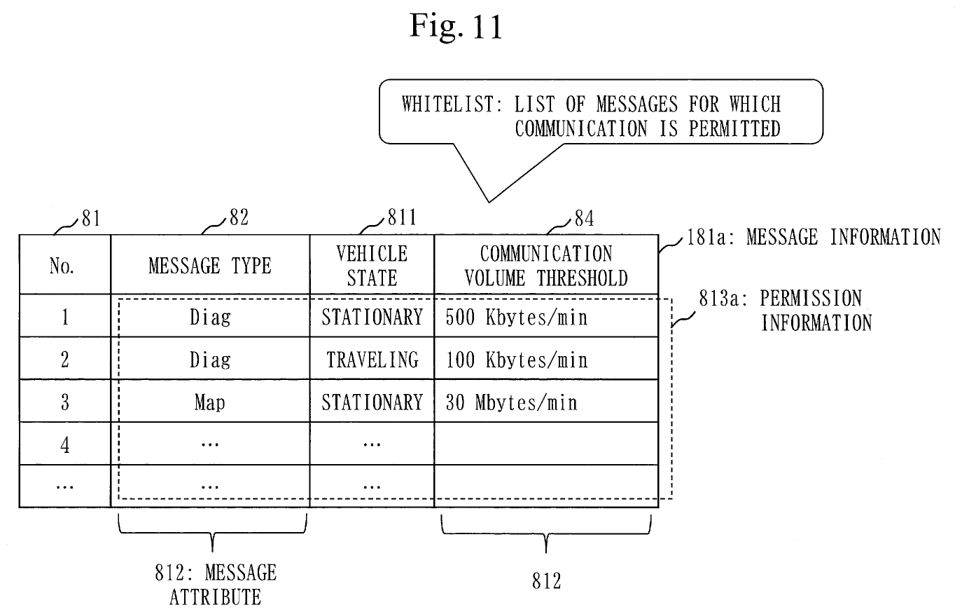

The message information 181a according to this embodiment will be described with reference to FIG. 11.

The message information 181a illustrated in FIG. 11 is a whitelist and messages for which communication is permitted are described in the table. In the message information 181a, messages for which communication and transfer are permitted are set. In this case, a message attribute 812 set in the message information 181a is permission information 813a indicating that the communication of the message is permitted. However, as in the first embodiment, the message information 181a may be such that messages for which communication is prohibited are described in the table as a blacklist. The message information 181a may also be configured to include a flag for determining whether the communication is permitted.

In the message information 181a illustrated in FIG. 11, a row number 81, a message type 82, a vehicle state 811, and a communication volume threshold 84 are registered. The row number 81, the message type 82, and the vehicle state 811 are substantially the same as those in FIG. 2 of the first embodiment. The communication volume threshold 84 is an example of the message attribute 812 that specifies a message. The communication volume threshold 84 is a threshold for the communication volume of the message to be communicated. Specifically, the communication volume threshold 84 is a threshold for the communication volume that is permitted in each vehicle state 811 for each message type 82. The specific example in FIG. 11 indicates that up to 500 Kbytes/min is permitted for a Diag message when the vehicle is stationary.

***Description of Operation***

A vehicle communication monitoring process S100a of a vehicle communication monitoring method 610a and a vehicle communication monitoring program 620a according to this embodiment will be described with reference to FIGS. 5, 6, and 12 to 14. FIGS. 5, 6, and 12 to 14 are diagrams illustrating an example of flowcharts when the vehicle communication monitoring apparatus 100a receives a message from the external system 601. Note that the flowcharts of FIGS. 5, 6, and 12 to 14 describe a case where the message information 181a of the whitelist type illustrated in FIG. 11 is used.

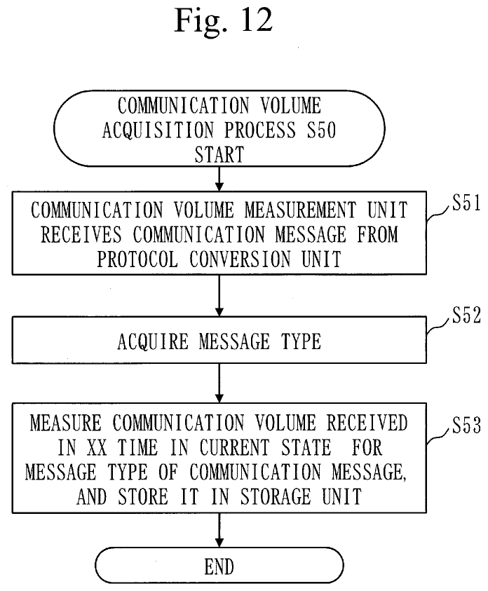

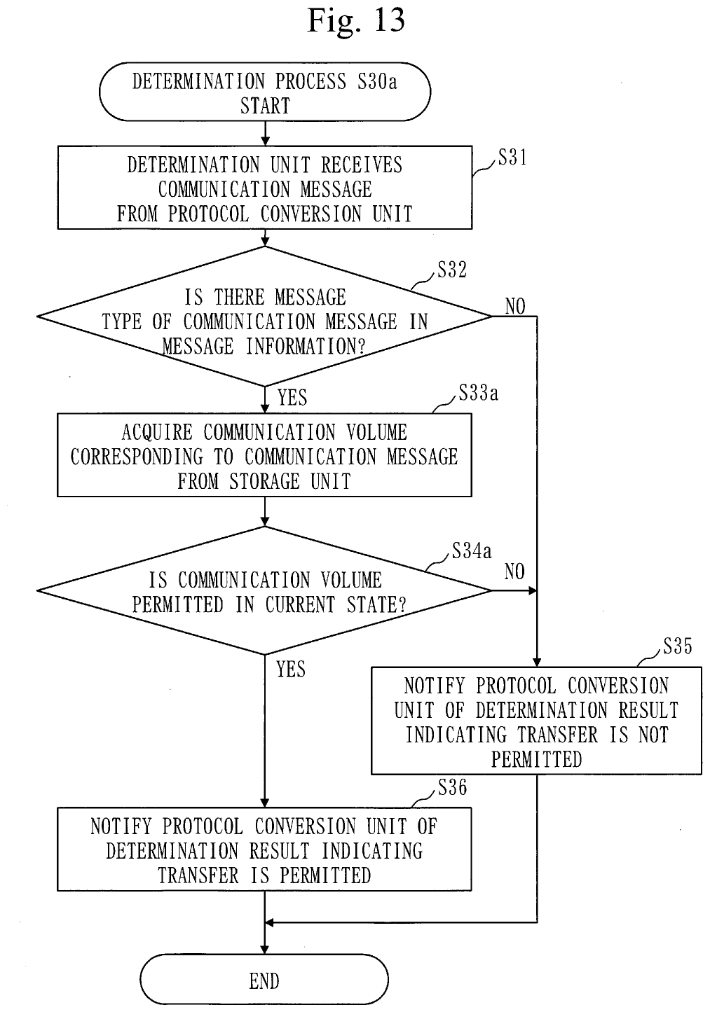

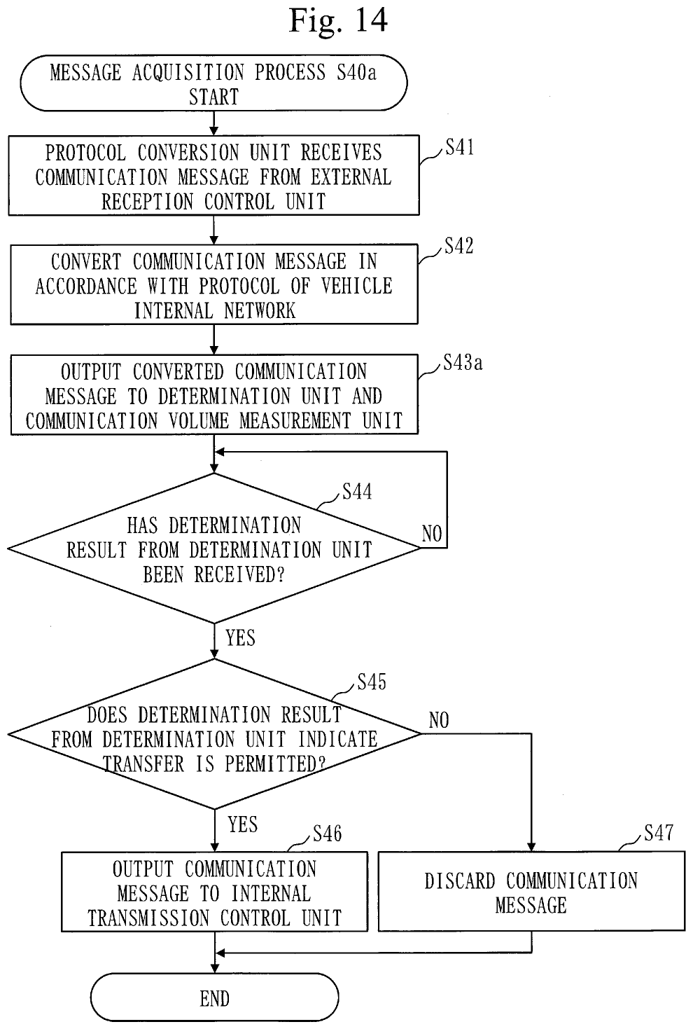

The vehicle communication monitoring process S100a has a message information acquisition process S10 of FIG. 5, a state acquisition process S20 of FIG. 6, a communication volume acquisition process S50 of FIG. 12, a determnination process S30a of FIG. 13, and a message acquisition process S40a of FIG. 14.

<Message Information Acquisition Process S10 and State Acquisition Process S20>

The message information acquisition process S10 and the state acquisition process S20 are substantially the same as those of the first embodiment described with reference to FIGS. 5 and 6.

<Communication Volume Acquisition Process S50>

The communication volume acquisition process S50 according to this embodiment will be described with reference to FIG. 12.

In the communication volume acquisition process S50, the communication volume measurement unit 190 acquires the current state of the vehicle as the current state 182. A specific process of the state acquisition process S20 is as described below.

In step S51, the communication volume measurement unit 190 receives the communication message 501 from the protocol conversion unit 150.

In step S52, the communication volume measurement unit 190 acquires the message type of the communication message 501 received from the protocol conversion unit 150. The communication volume measurement unit 190 also acquires the current state 182 from the storage unit 180.

In step S53, the communication volume measurement unit 190 measures the communication volume received in an XX time for the acquired communication message 501. Note that the XX time is an arbitrary time. The communication volume measurement unit 190 overwrites the communication volume 183 in the storage unit 180, using the measured communication volume as the communication volume received in the current state 182 for the message type of the communication message 501. Note that the XX time is an arbitrary time.

<Determination Process S30a>

In the determination process S30a, based on the current state 182, the communication volume 183 of the communication message 501, and the message information 181a, the determination unit 160 determines whether the communication volume 183 is within the communication volume threshold 84 when the vehicle is in the current state 182. The determination unit 160 determines whether the communication of the communication message 501 is permitted, based on whether the communication volume 183 is within the communication volume threshold 84. A specific process of the determination process S30a is as described below.

The determination process S30a according to this embodiment will be described with reference to FIG. 13.

In step S31, the determination unit 160 receives the communication message 501 from the protocol conversion unit 150. The determination unit 160 acquires the communication message attribute 502 that specifies the communication message 501. The communication message attribute 502 includes a message type of the communication message 501.

In step S32, the determination unit 160 checks whether the message type 82 of the message information 181 acquired in the message information acquisition process S10 includes one corresponding with the message type included in the communication message attribute 502. If there is one, the process proceeds to step S33a. If there is none, the process proceeds to step S35.

Note that processes of step S31 and step S32 are substantially the same as those of the first embodiment described with reference to FIG. 7.

In step S33a, the determination unit 160 analyzes the communication message 501, and acquires the communication volume 183 corresponding to the communication message 501 from the storage unit 180.

In the step S34a, based on the message information 181, the current state 182 of the vehicle, and the communication volume 183 of the communication message 501, the determination unit 160 determines whether the communication volume 183 of the communication message 501 is within the communication volume threshold 84 when the vehicle is in the current state 182. If it is within the communication volume threshold 84, the process proceeds to step S36. If not permitted, the process proceeds to step S35.

In step S35, the determination unit 160 outputs to the protocol conversion unit 150 the determination result 161 indicating that the transfer is not permitted.

In step S36, the determination unit 160 outputs to the protocol conversion unit 150 the determination result 161 indicating that the transfer is permitted.

Note that processes of step S35 and step S36 are substantially the same as those of the first embodiment described with reference to FIG. 7.

<Message Acquisition Process S40a>

The message acquisition process S40a according to this embodiment will be described with reference to FIG. 14.

Processes from step S41 to step S42 and from step S44 to step S47 are substantially the same as those of the first embodiment described with reference to FIG. 8. A process different from FIG. 8 of the first embodiment is step S43a.

In step S43a, the protocol conversion unit 150 outputs the converted communication message 501 to the determination unit 160 and the communication volume measurement unit 190.

***Other Configurations***

As in the first embodiment, the vehicle communication monitoring apparatus 100a according to this embodiment may include a function of, upon blocking an unauthorized message, notifying a driver via an output device such as a in-vehicle display or a speaker. This function allows the driver to recognize that the in-vehicle system 602 is under attack and take countermeasures such as stopping the vehicle.

Also in this embodiment, as in the first embodiment, a message from the inside of the vehicle to the outside of the vehicle may also be processed similarly. This can prevent leakage of confidential information or private information by an unauthorized operation of the in-vehicle system 602. Note that when a message from the inside of the vehicle to the outside of the vehicle is processed, the protocol conversion unit transmits a message before protocol conversion received from the internal reception control unit to the determination unit as a communication message. Then, if the determination result from the determination unit indicates that the transfer is permitted, the protocol conversion unit converts the protocol of the communication message and outputs the converted communication message to the external transmission control unit.

***Description of Effects According to This Embodiment***

The vehicle communication monitoring apparatus 100a according to this embodiment recognizes the state of the vehicle, and prohibits the transfer of a message in excess of the communication volume permitted in the current state of the vehicle, thereby preventing hacking of the in-vehicle system 602 by intrusion of an unauthorized message into the vehicle internal network. According to the vehicle communication monitoring apparatus 100a of this embodiment, the detailed message content of a message is not checked. Therefore, as long as the destination of the message, such as the head unit or the ECU to be the transmission destination, can be determined, an unauthorized message can be blocked even in encrypted communication.

The first and second embodiments have been described above. In the first and second embodiments, the units of the vehicle communication monitoring apparatus constitute the vehicle communication monitoring apparatus as independent functional blocks. However, the configuration may be different from those described in the above-described embodiments, and the configuration of the vehicle communication monitoring apparatus may be any configuration. Any functional blocks may constitute the vehicle communication monitoring apparatus, provided that the functions described in the above-described embodiments can be realized. The vehicle communication monitoring apparatus may be configured with any other combination of these functional blocks or any block configuration.

The vehicle communication monitoring apparatus may be a system configured with a plurality of apparatuses, instead of a single apparatus.

The first and second embodiments have been described. A plurality of portions of these two embodiments may be implemented in combination. Alternatively, one portion of these embodiments may be implemented. Alternatively, these embodiments may be implemented as a whole or partially in any combination.

Note that the above-described embodiments are essentially preferred examples and are not intended to limit the scope of the present invention and the scopes of applications and intended uses of the present invention, and various modifications are possible as necessary.

### REFERENCE SIGNS LIST

50: message acquisition unit; 100, 100a: vehicle communication monitoring apparatus; 110: external transmission control unit; 120: external reception control unit; 130: internal transmission control unit; 140: internal reception control unit; 150: protocol conversion unit; 160: determination unit; 161: determination result; 170: state acquisition unit; 180: storage unit; 181, 181a, 181x, 181y: message information; 182: current state; 183: communication volume; 190: communication volume measurement unit; 81: row number; 82: message type; 83: detailed message content; 84: communication volume threshold; 501: communication message; 502: communication message attribute; 601: external system; 602: in-vehicle system; 610, 610a: vehicle communication monitoring method; 620, 620a: vehicle communication monitoring program; 811: vehicle state; 812: message attribute; 813, 813x, 813y: permission information; 909: processing circuit; 910: processor; 920: storage device; 921: memory; 922: auxiliary storage device; 930: input interface; 940: output interface; 951: external interface; 952: internal interface; S100: vehicle communication monitoring process; S10: message information acquisition process; S20: state acquisition process; S30, S30a: determination process; S40: message acquisition process; S50: communication volume acquisition process.

1. A vehicle communication monitoring apparatus comprising:
processing circuitry to:
store message information in which a vehicle state that indicates a state of a vehicle, a message attribute that specifies a message to be communicated, and permission information that indicates whether communication of the message specified by the message attribute is permitted are associated with one another;
acquire a current state of the vehicle as a current state;
acquire, as a communication message, a message to be communicated between an in-vehicle system installed in the vehicle and an external system not installed in the vehicle, perform protocol conversion for communication inside the in-vehicle system on the communication message that has been acquired, and output the communication message after the conversion; and
acquire, as a communication message attribute, a message attribute that specifies the communication message that has been input, and based on the current state, the communication message attribute, and the message information, determine whether communication of the communication message is permitted when the vehicle is in the current state, and output a determination result,
wherein the processing circuitry discards the communication message when the determination result indicates that the communication is not permitted.

2. The vehicle communication monitoring apparatus according to claim 1,
wherein the processing circuitry includes, as the vehicle state, at least one of a traveling state of the vehicle and an open or closed state of a door of the vehicle.

3. The vehicle communication monitoring apparatus according to claim 1,
wherein the processing circuitry includes, as the message attribute, a type of the message to be communicated.

4. The vehicle communication monitoring apparatus according to claim 3,
wherein the processing circuitry includes, as the message attribute, content of the message to be communicated.

5. The vehicle communication monitoring apparatus according to claim 3,
wherein the processing circuitry includes, as the message attribute, a communication volume threshold for a communication volume of the message to be communicated.

6. The vehicle communication monitoring apparatus according to claim 5,
wherein the processing circuitry acquires the communication message, and measure a communication volume of the communication message, and
based on the current state, the communication volume of the communication message, and the message information, determines whether the communication of the communication message is permitted, based on whether the communication volume is within the communication volume threshold when the vehicle is in the current state.

7. The vehicle communication monitoring apparatus according to claim 1,
wherein the message information is a whitelist such that a fact that the message attribute is set therein indicates that communication of the message specified by the message attribute is permitted.

8. The vehicle communication monitoring apparatus according to claim 1,
wherein the message information is a blacklist such that a fact that the message attribute is set therein indicates that communication of the message specified by the message attribute is not permitted.

9. (canceled)

10. The vehicle communication monitoring apparatus according to claim 1,
wherein when the determination result indicates that the communication is not permitted, the processing circuitry discards the communication message, and also outputs to an output device an indication that the communication of the communication message is not permitted.

11. A vehicle communication monitoring method for a vehicle communication monitoring apparatus including processing circuitry to store message information in which a vehicle state that indicates a state of a vehicle, a message attribute that specifies a message to be communicated, and permission information that indicates whether communication of the message specified by the message attribute is permitted are associated with one another, the vehicle communication monitoring method comprising:
acquiring a current state of the vehicle as a current state;
acquiring, as a communication message, a message to be communicated between an in-vehicle system installed in the vehicle and an external system not installed in the vehicle, performing protocol conversion for communication inside the in-vehicle system on the communication message that has been acquired, and outputting the communication message after the conversion; and
acquiring, as a communication message attribute, a message attribute that specifies the communication message, and based on the current state, the communication message attribute, and the message information, determining whether communication of the communication message is permitted when the vehicle is in the current state, and outputting a determination result,
wherein the communication message is discarded when the determination result indicates that the communication is not permitted.

12. A non-transitory computer readable medium storing a vehicle communication monitoring program for a vehicle communication monitoring apparatus including processing circuitry to store message information in which a vehicle state that indicates a state of a vehicle, a message attribute that specifies a message to be communicated, and permission information that indicates whether communication of the message specified by the message attribute is permitted are associated with one another, the vehicle communication monitoring program causing the vehicle communication monitoring apparatus, which is a computer, to execute:
a state acquisition process to acquire a current state of the vehicle as a current state;
a message acquisition process to acquire, as a communication message, a message to be communicated between an in-vehicle system installed in the vehicle and an external system not installed in the vehicle, perform protocol conversion for communication inside the in-vehicle system on the communication message that has been acquired, and output the communication message after the conversion;
a determination process to acquire, as a communication message attribute, a message attribute that specifies the communication message, and based on the current state, the communication message attribute, and the message information, determine whether communication of the communication message is permitted when the vehicle is in the current state, and output a determination result and
a process to discard the communication message when the determination result indicates that the communication is not permitted.
